(19) United States
(12) Patent Application Publication
(10) Pub. No.: US 2025/0281999 A1
(43) Pub. Date: Sep. 11, 2025

(54) Method and Apparatus to Laser Weld Compliant Sheets of Material

(71) Applicant: Photon Applications, LLC, Plainfield, IN (US)

(72) Inventors: Alan Feinerman, Skokie, IL (US); David Stucker, Plainfield, IN (US)

(73) Assignee: Photon Applications, LLC, Plainfield, IN (US)

(21) Appl. No.: 18/804,751

(22) Filed: Aug. 14, 2024

Related U.S. Application Data
(60) Provisional application No. 63/563,734, filed on Mar. 11, 2024.

(51) Int. Cl. B23K 26/21; B23K 26/12; B23K 26/70; B23K 37/04; B23K 101/38; B23K 103/00

(52) U.S. Cl. CPC B23K 26/21; B23K 26/1224; B23K 26/70; B23K 37/0435; B23K 2101/38; B23K 2103/50

(57) ABSTRACT

A method and apparatus for laser welding compliant sheets. Select a material for the sheets. Layer a selected number of sheets of the material to weld at a weld area. Assemble the sealed fixture with the plurality of sheets within the sealed fixture assembly. Create a vacuum or partial pressure within the sealed fixture assembly. Laser-weld the sheets at the weld area. An apparatus for performing the method is also presented.

This application claims priority to Provisional Application No. 63/563,734 filed Mar. 11, 2024 titled “Method to Assist in the Laser Welding of Micron Thickness Foils” to the extent allowed by law.

### FIELD OF THE INVENTION

A method and apparatus for laser welding compliant sheets of material.

### PROBLEM TO BE SOLVED

With the recent proliferation of manufacturing batteries for electrification, the use of compliant sheets or foils as an anode and/or cathode material have increased. Traditional techniques to weld together these foils may include ultrasonic welding or, more recently, laser welding. A typical pouch battery, as a mere example, can or could utilize anywhere from 2 to 60layers of foil to construct an anode or cathode for a battery's cell. Ultrasonic welding inherently limits the layers of foil to 40-60 sheets as the overall thickness of the foil stack will become too great to create an electrical connection. This thickness limitation, in turn, limits the cell output of the battery as the current/power is capped due to this 40-60 sheet limitation.

Thus, the industry has looked at and moved to utilizing laser welding rather than ultrasonic welding to increase the layer count of anodes and cathodes. Laser welding easily allows the foil stacks to surpass 100 layers. However, unlike ultrasonic welding, laser welding is a non-contact process. As a result, this non-contact laser process can allow air gaps between the foil sheets of what is being welded. These air gaps can significantly diminish the quality and integrity of the welds created by the laser as well as lead to the inadvertent cutting of the foil itself at the intended weld location(s). To solve this issue, a clamp with a hollow center or set of clamps can be used to secure the foil stacks and minimize the air gaps where the weld occurs. The clamp is hollow, as in it has an aperture, as not to block the laser beam(s) from irradiating the foils and avoid the laser beam(s) from irradiating the clamp. Further, the clamps do not always remove the air gaps entirely as they have a hollow center and thus do not create consistent pressure throughout the foil stack. Therefore, it would be advantageous if these and other foil stacks could be welded utilizing a laser welder and minimize the air gaps without utilizing an inefficient hollow clamp method of clamping.

### DESCRIPTION OF PRIOR ART

All known prior art references are publications relating to the fabrication of plastic micro channels. In several of these items of prior art, it is discussed that a vacuum could be used to bring thermoplastic films together in order to weld them via a CO₂ laser. Specifically, the prior art entitled COMPLIANT MICROMIXERS (IMECE2010-38991) states that first thermoplastic sheet can be placed upon a second thermo plastic sheet, and then a vacuum is used to remove the air between the sheets. Then, a CO₂ laser was utilized to create microchannels within the adjoined pieces of thermoplastics. This would result in the creation of a microfluidic mixer. This prior art fails to accomplish what is necessary to laser weld compliant sheets as utilized for an anode or cathode, unlike the presently disclosed invention.

### OBJECTIVE OF THE INVENTION

The present invention provides a method and apparatus for laser welding compliant sheets of material, including but not limited to a plurality of foil sheets that comprise an anode or cathode within a battery. The method can be applied to any compliant sheet material that requires close contact for successful laser welding. This method is more efficient than previously disclosed methods and results in the improved quality of laser welds, especially in the field of battery technologies. The present method prevents the destruction of a plurality of sheets to be welded as well as minimizing or eliminating capillary action, thereby inhibiting molten sheet material from flowing between the gapped layers, which results in increased porosity within the weld and decreases the efficiency of the electrical connection.

### SUMMARY OF THE INVENTION

In one embodiment of the presently disclosed method, a sealed fixture assembly is used in conjunction with a partial pressure, or vacuum that is introduced between a plurality of sheets of material or foil to bring the sheets into intimate contact with each other. The selected sheets are a plurality and are stacked one on top of the other. The plurality of sheets are then placed and will reside between the upper and lower portions of the sealed fixture assembly. The sealed fixture assembly can be made of various materials including metal, wood, glass, plastic and other organic materials. A vacuum hose is inserted into an aperture of the sealed fixture assembly. The vacuum hose is controlled via a vacuum apparatus in order to reach a partial pressure or vacuum to bring the plurality of sheets into intimate contact. The plurality of sheets can be brought together throughout the stack of the plurality of sheets, or specifically at the weld site of the sheets. This is cell and terminal dependent. A laser welder can then be utilized with the correct parameters in relation to the material of the foil to produce a proper weld. These parameters can include but are not limited to focal length, focus position, power density, pulse duration, beam diameter, and welding speed. Additionally, the laser focus may travel in any desired pattern and parameters can change depending on the material being welded and the laser being used.

Another embodiment could contain a first and a second set of a plurality of sheets rather than a single set of a plurality of sheets. For example, the cell for a battery can be welded together. A plurality of the first set of sheets would comprise an anode material. A plurality of the second set of sheets would comprise a cathode material. During welding, these pluralities of the first and second sets of sheets would be interleaved with a separation layer and/or a solid electrolyte to create a cell. The general structure being anode, separation layer and/or solid electrolyte, and cathode, with this repeating until the desired number of anode and cathode sets are present. The sealed fixture assembly would encompass the plurality of stacks comprising cell. Upon a partial pressure or vacuum being achieved, the plurality of sheets within the anode and cathode sets would be brought into intimate contact, respectively. A laser would then weld the sets of anodes to each other at the weld site, and the same would be done for the sets of cathodes. In this embodiment, and others where the plurality of sheets may have two or more weld areas, both weld areas could be welded from the same fixture position. However, at times the plurality of sheets themselves, the laser, or the fixture may need to be repositioned or rotated in order to properly weld all weld areas based upon cell configuration.

As described above certain embodiments will utilize the method and apparatus of this application with anode materials and cathode materials with an electrolyte and separation layer between the two. Cathodes or cathode active materials are often metal oxides for example; lithium-ion batteries include lithium cobalt oxide (LiCoO₂), lithium manganese oxide (LiMn₂O₄), lithium iron phosphate (LiFePO₄ or LFP), and lithium nickel manganese cobalt oxide (LiNiMnCoO₂ or NMC) please see https.//aquametals.com/recyclopedia/lithium-ion-anode-and-cathode-materials/ for more information. As well, aluminum foil is often used as a cathode material. Anodes or anode reactive materials are often carbon based materials such as graphite, silicon, or both in combination, please see https:/aquasmetals.com/recyclopedia/lithium-ion-anode-and-cathode-materials/ for more information. Anode materials can also include copper foils, nickel foils and rolled copper alloy foils, please see https://www.targray.com/li-ion-battery/anode-materials/foils for more information. These examples of anode and cathode materials serve as mere examples as to what anode and cathode materials could be and are not an exhaustive list of available or possible materials that could be used as an anode or cathode.

The sealed fixture assembly is comprised of an upper and a lower portion. Each of the upper and lower portions have a gasket, an O-ring, or another means to create a seal upon the sheet contacting side. The body of the sealed fixture itself may extend past the gasket or O-ring towards the weld area. This extended portion of the sealed fixture assembly can minimize inadvertent exposure of the laser's energy to the gasket or O-ring and other temperature-sensitive components. The fixture may be of any shape or size necessary to work with the shape and size of the sheets that are chosen to be welded. The sealed fixture has a vacuum port to receive a vacuum hose. The vacuum port and vacuum hose have a gas tight mechanical connection. The vacuum port can be anywhere along the sealed fixture assembly as long as it does not interfere with the welding device. The body of the upper and lower portions of the sealed fixture assembly have a sheet contacting surface and a fixture contacting surface. A gasket or O-ring is located between the fixture contacting surfaces.

In some embodiments, it may be desirable to use additional gas or pressure surrounding the plurality of sheets within the sealed fixture assembly that is not atmospheric. These embodiments may utilize an inert gas or reactive gas to achieve desired shielding or temperature-regulating effects. Additionally, these embodiments may utilize larger or smaller pressure than atmospheric pressure, which would benefit the use of a welding laser in this application.

In additional embodiments, the sealed fixture assembly could be used with additional securing methods. Such methods could include but are not limited to “sacrificial sheets” or additional clamping. The sacrificial sheets method would utilize the method previously disclosed but introduce a first and a second sacrificial foil sheet with the plurality of sheets in between the first and second sheets. This increases the distance between the welded region and the sealed fixture assembly to ensure a proper weld. These sacrificial sheets can be of any desired material that doesn't prevent the welding operation. Including additional clamps utilizes the method previously described as well. In this embodiment, the plurality of sheets would sit within the sealed fixture assembly as previously mentioned. A vacuum would be drawn, and additional hollow or non-hollow clamps can be placed about the welding area to increase the intimate contact of a plurality of sheets if deemed necessary.

An additional embodiment allows the bottom O-ring or gasket to be eliminated. In this embodiment the fixture extends across the entire stack of sheets or the entire electrode stack. The top of the fixture can extend past the top inner O-ring to the weld area, as long as an opening remains for the laser beam illumination. This embodiment minimizes inadvertent exposure of the laser's energy by the O-ring as well as other temperature sensitive components. This embodiment is particularly useful, for example, if the plurality of sheets is to be welded to a thicker tab that facilitates electrical attachment to the cell. This tab can be located at the bottom of the plurality of sheets but does not have to be.

In some circumstances it may be necessary to utilize “double pumping” along with the method of this application. In these instances it would be difficult to have the fixture completely surround the plurality of foil sheets that need to be welded. For example when the foil stack, comprised of n number of sheets, extends beyond the outside of a fixture. This can prevent the gasket or O-ring of the fixture from sealing completely as the gasket or O-ring will be in contact with areas that have no foil sheets and then areas with the complete plurality of foil sheets. This incomplete seal will allow the fixture to leak when a vacuum is pulled resulting in the sheets not being in sufficient intimate contact. Thus, in order to remedy this issue one or more vacuum ports can be added adjacent to the foil stacks and connected to a second vacuum source. This arrangement minimizes the leakage where the gasket or O-ring spans the transition from no foil sheets to the complete plurality of foil sheets when the foil sheets extend beyond the fixture.

In some instances some embodiments may benefit from metal shielding. The O-rings or gaskets of the fixture assembly are at times made of an elastomer. These elastomers can be damaged by stray light from the laser welding. Thus a column or double column of metal fingers can be used in order to act as a light tight shielding gasket. The column or double column of metal fingers are spaced in order to minimize the exposure of light to the elastomers. This arrangement also allows the fixture to be expanded to smooth and flatten the plurality of sheets of foil where they are to be welded.

### BRIEF DESCRIPTION OF DRAWINGS

FIG. 1 is an expanded schematic perspective view of a simplified fixture layout with no detail.

FIG. 2 is a perspective view of a simplified assembled fixture with minimal detail.

FIG. 3 is a cross-section of the assembled fixture with a plurality of sheets of material.

FIG. 4 is a plan side-by-side of a simplified fixture with an anode and cathode.

FIG. 5 is a plan side-by-side view of a fixture with a spacer.

FIG. 6 is a plan top-down view of a simplified fixture with auxiliary vacuum ports.

FIG. 7 is a plan cross-section of the fixture with metal fingers.

### DETAILED DESCRIPTION OF DRAWINGS

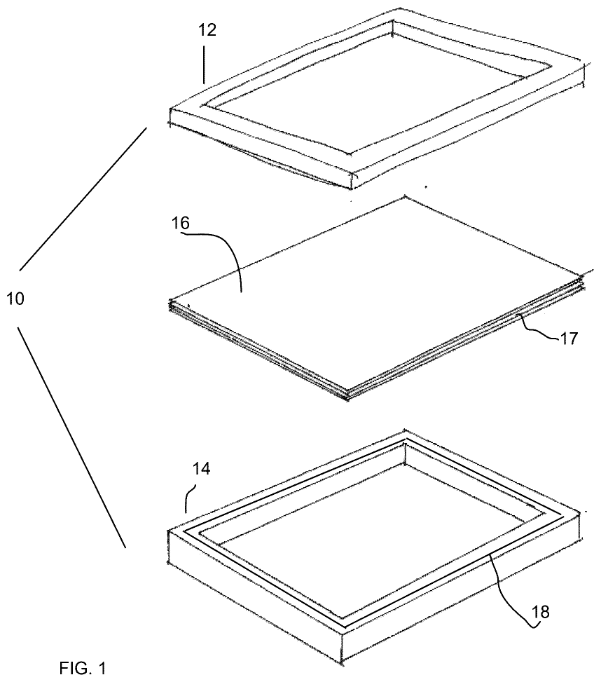

FIG. 1 is an expanded schematic perspective view of a simplified, sealed fixture assembly 10 with no detail illustrated. The upper portion 12 and the lower portion 14 are shown above and below the plurality of sheets 16, 17 to be welded, which may be (n) sheets thick. A gasket 18 is attached on the sheet-contacting portion of the upper portion 12 (not shown) and on the lower portion 14. The sealed fixture assembly 10 and a plurality of sheets 16, 17, are depicted as rectangles as a simplified example, but can be of any shape and size.

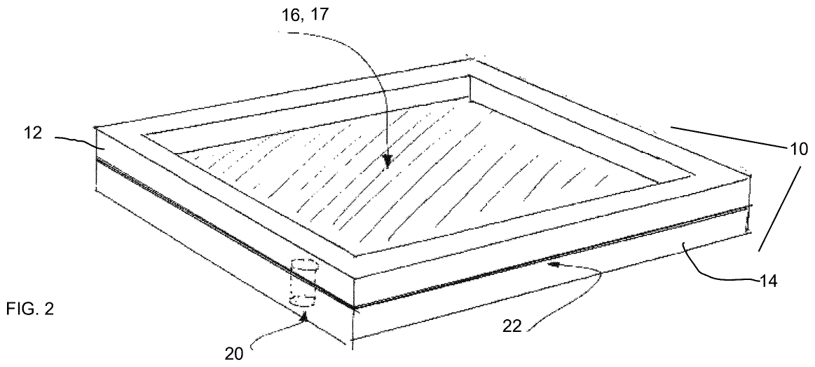

FIG. 2 is a perspective view of a simplified assembled sealed fixture assembly 10. The upper portion 12 and lower portion 14 of the sealed fixture assembly 10 seals the plurality of sheets 16, 17 when assembled. A vacuum port 20 can be seen within the sealed fixture assembly 10. The sealed fixture assembly 10 creates a gas tight seal 22 when assembled.

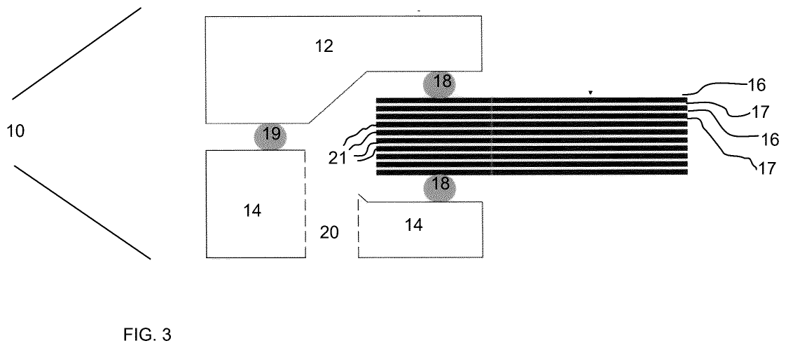

FIG. 3 is a cross-section of the assembled sealed fixture assembly 10. The upper portion 12, and the lower portion 14 can be seen securing the plurality of sheets 16, 17. A gasket 18 is disposed between the plurality of sheets 16, 17 and the upper portion 12 and the lower portion 14. An additional gasket 19 can be seen between the upper portion 12 and the lower portion 14. The vacuum port 20 is shown within the sealed fixture assembly 10. This is one example of the vacuum port 20 and should not be considered limiting. Between the plurality of sheets 16, 17 a solid electrolyte and/or and separation layer 21 is disposed, but the solid electrolyte and/or separation layer do not extend into where the plurality of sheets 16, 17 are welded.

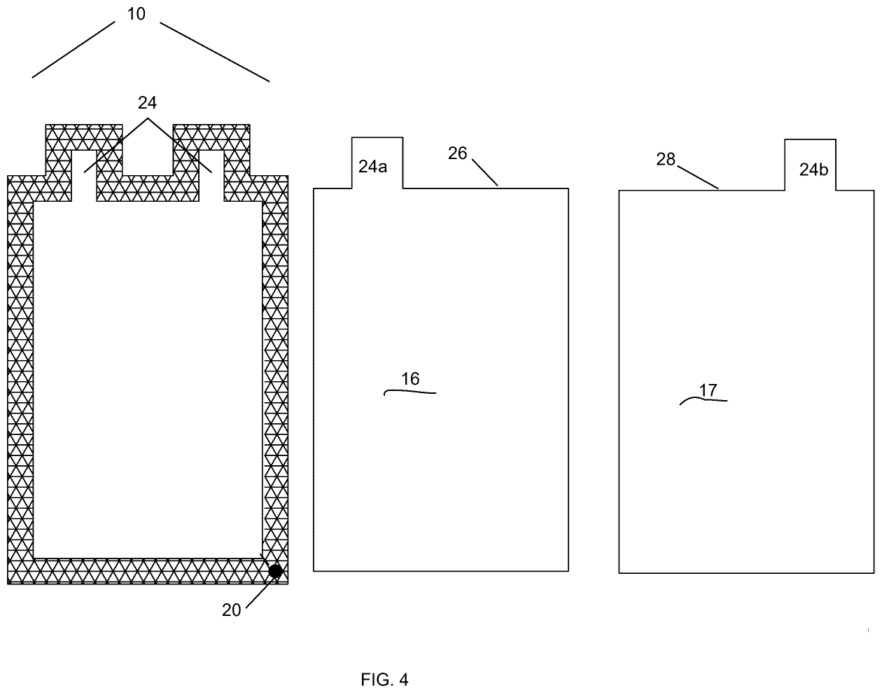

FIG. 4 is a plan side-by-side view of a simplified sealed fixture assembly 10 with minimal detail. An example of a plurality of sheets 16, 17 to be welded is shown, with two sets of a plurality of sheets 16 and 17 comprising an anode 26 and a cathode 28. The sealed fixture assembly 10, in this example, takes the shape of the anode 26 and the cathode 28. The weld regions 24a and 24b of both the anode 26 and the cathode 28 are depicted, and are located on opposite lateral sides of the anode 26 and the cathode 28. The welding of the anode 26 at its weld area 24a and the welding of the cathode 28 at its weld area 24b can be accomplished within the same fixture without reposition the fixture 10. The vacuum port 20 is depicted in the lower right corner of the sealed fixture assembly 10, but may be placed anywhere about the sealed fixture assembly 10.

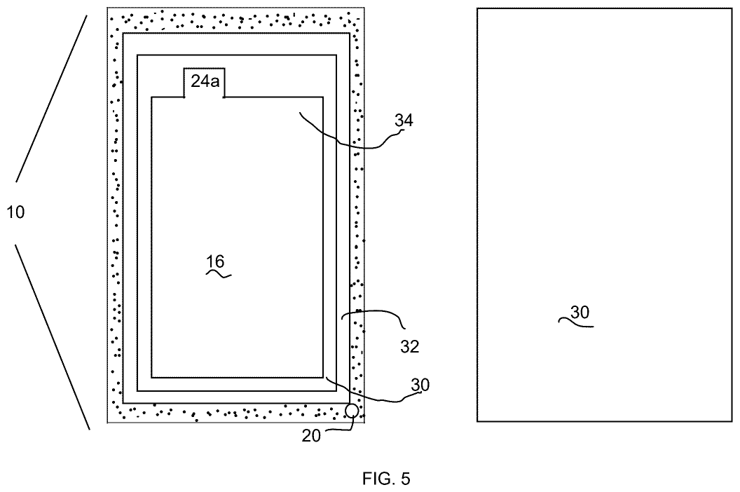

FIG. 5 is a plan side-by-side view of a sealed fixture assembly 10 utilizing sacrificial larger foils 30 and a spacer 32. A larger foil 30 is placed on top and below the plurality of sheets 16 in this example, represented by an electrode 34. The spacer 32 is placed between the larger foil 30 sheets and sealed fixture assembly 10. Once the electrodes 34 have been welded together at weld region 24a, the larger foils 30 can be trimmed or removed and spacer 32 can be removed. A vacuum or partial pressure is still created via the vacuum port 20.

In one embodiment utilizing a plurality of sheets 16, 17 that comprise an anode 26 and a cathode 28, the weld areas 24a and 24b of a plurality of sheets 16 and 17 are placed in alternating layers of anode 26 and then cathode 28 within the sealed fixture assembly 10. A solid electrolyte and/or separation layer 21 is disposed between the alternating sheet layers 16, 17, but there is no electrolyte or separation layer 21 between the plurality of sheets at the weld areas 24a and 24b. A vacuum is created via the vacuum port 20 bringing the plurality of sheets 16, 17 into intimate contact at the weld areas 24a and 24b. The sealed fixture assembly 10 leaves open and accessible weld areas 24a and 24b of the plurality of sheets 16, 17. The weld areas 24a and 24b are depicted as a rectangle or tab in FIG. 4 and FIG. 5, but the weld areas 24a and 24b can be of any necessary shape and in any necessary location. A laser welder is then utilized to weld the plurality of sheets 16 and 17 to themselves at weld areas 24a and 24b respectively. The weld can be of any pattern deemed necessary by the welder, but is still at the weld areas 24a and 24b. As previously stated, the parameters of the laser weld are selected by the welder, the parameters being dependent on the materials comprising a plurality of sheets 16, 17, the laser welder itself, and the environment in which the weld is completed.

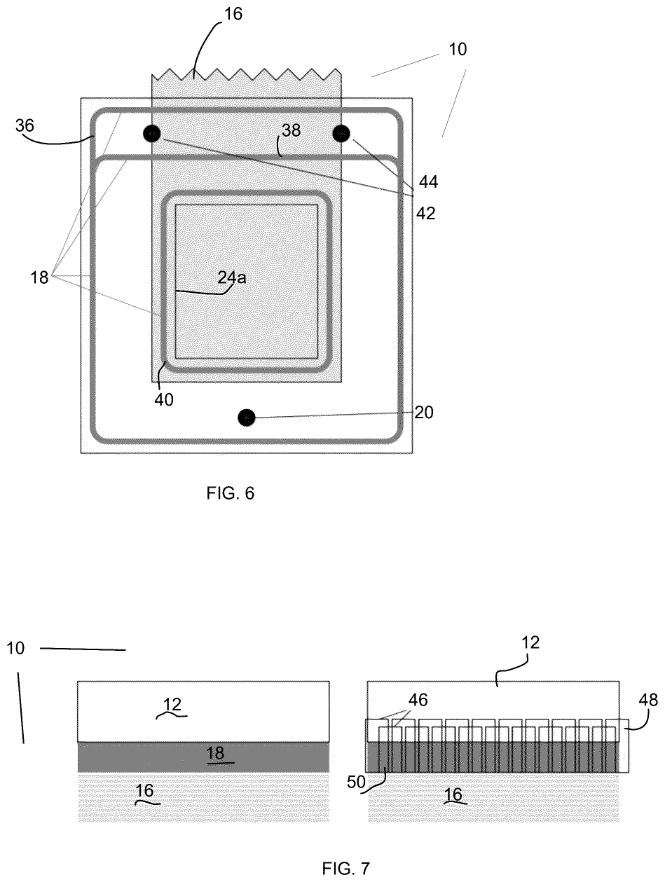

FIG. 6 is a plan top-down view of a simplified fixture of an alternate embodiment with auxiliary vacuum ports 42, 44 which are configured to receive an additional vacuum source. In this embodiment the plurality of sheets 16, 17 (not visible) extend beyond the sealed fixture assembly 10 as the weld areas 24a and 24b are placed within the sealed fixture assembly 10 rather than the plurality of sheets 16, 17. Three elastomer gaskets 36, 38, 40 seal the fixture 10 and the stacked plurality of sheets 16, 17 of foil only at the weld areas 24a and 24b. Two additional auxiliary vacuum ports 42, 44 are placed on opposed sides of the plurality of sheets 16, 17 with the single vacuum port 20 below in a lower portion of the sealed fixture assembly 10. As in the previous embodiments, a vacuum is drawn from the auxiliary vacuum ports 42, 44 and the vacuum port 20 to bring the weld areas 24a and 24b (FIG. 4) of the plurality of sheets 16, 17 into intimate contact, and to allow the elastomer gaskets 36, 38, 40 to properly form about the sealed fixture assembly 10.

FIG. 7 is a plan cross-section of the sealed fixture assembly 10 with metal fingers 46. The metal fingers 46 comprise two columns 48, 50 that are attached to the sealed fixture assembly 10, in this embodiment the upper portion 12, and directed downwards towards the plurality of sheets 16. The metal fingers 46 are positioned to both prevent light from the laser welder from projecting onto the seal or gasket 18, in this example made of an elastomer, and ensure a proper seal. The plurality of sheets 16 sit beneath the gaskets 18.

While the present disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A method for laser welding compliant sheets, comprising;
selecting a material for the sheets;
layering a plurality of sheets of the material to weld at a weld area;
assembling the plurality of sheets within a sealed fixture assembly;
creating at least one of a vacuum and a partial pressure within the sealed fixture assembly including at the weld area;
laser welding the plurality of sheets at the weld area.

2. The method for laser welding compliant sheets of claim 1, wherein a first set of the plurality of sheets of material and a second set of the plurality of sheets of material are placed within the sealed fixture assembly, each set of the first and second plurality of sheets having a separate weld area, the separate weld areas being welded separately.

3. The method for laser welding compliant sheets of claim 2, wherein the first set of the plurality of sheets of material comprise an anode material and the second set of the plurality of sheets comprise a cathode material.

4. The method for laser welding compliant sheets of claim 2, wherein at least one of an electrolyte layer and a separation layer are disposed between the first set of the plurality of sheets of material and the second set of the plurality of sheets of material.

5. The method for laser welding compliant sheets of claim 3, wherein the first set of the plurality of sheets of material and the second set of the plurality of sheets of material are each one of a plurality of sets.

6. The method for laser welding compliant sheets of claim 1, wherein the plurality of sheets of material include a plurality of types of material.

7. The method for laser welding compliant sheets of claim 1, wherein a first and a second sacrificial foil sheet are placed below and above, respectively, the plurality of sheets, the first and the second sacrificial foil sheets having an additional spacer.

8. The method for laser welding compliant sheets of claim 1, wherein the plurality of sheets of material are surrounded by at least one of a reactive gas and an inert gas.

9. The method for laser welding compliant sheets of claim 1, wherein the plurality of sheets of material and sealed fixture assembly are subjected to a pressure exceeding atmospheric pressure outside the plurality of sheets.

10. The method for laser welding compliant sheets of claim 1, wherein the sealed fixture assembly is constructed from at least one of a metal, a plastic, a glass and an organic materials

11. The method for laser welding compliant sheets of claim 1, wherein each sheet of the plurality of sheets is a foil sheet.

12. The method for laser welding compliant sheets of claim 1, wherein the sealed fixture assembly encloses the weld areas of the plurality of sheets, the sealed fixture assembly having at least two additional auxiliary vacuum ports adjacent the perimeter of the weld areas within the sealed fixture assembly.

13. The method for laser welding compliant sheets of claim 1, wherein the sealed fixture assembly has at least one column of metal fingers, the metal fingers attached to the sealed fixture assembly and positioned towards the plurality of sheets.

14. An apparatus for laser welding compliant sheets, comprising;
a sealed fixture assembly having an upper and a lower portion, the upper portion having a first elastomer gasket attached to a sheet-contacting side of the upper portion, the lower portion having a second elastomer gasket attached to a sheet-contacting side of the lower portion, the first and second elastomer gaskets configured to compress and seal the compliant sheets of material when the compliant sheets of material are located between the upper and lower portions;
at least one vacuum port disposed within the sealed fixture assembly, an opening for the vacuum port disposed within at least one of the upper and lower portions of the sealed fixture assembly, the at least one vacuum port configured to receive a vacuum source.

15. The apparatus for laser welding compliant sheets of claim 14, wherein the upper portion of the sealed fixture assembly comprises at least one column of metal fingers, the metal fingers attached to the sealed fixture assembly, the metal fingers positioned towards the plurality of sheets.

16. The apparatus for laser welding compliant sheets of claim 14, wherein the sealed fixture assembly is comprised of at least one of a metal, a plastic, a glass and an organic material.

17. The apparatus for laser welding compliant sheets of claim 14, wherein each of the gaskets is an O-ring.

18. The apparatus for laser welding compliant sheets of claim 14, wherein the sealed fixture assembly encloses only the weld areas of the plurality of sheets, the sealed fixture assembly having at least two auxiliary vacuum ports configured to receive vacuum sources.

19. A method for laser welding compliant sheets, comprising;
selecting a material for the sheets;
layering a plurality of sheets of the material to weld at a weld area;
assembling the plurality of sheets with the weld area disposed within a sealed fixture assembly;
creating at least one of a vacuum and a partial pressure within the sealed fixture assembly at the weld area;
laser-welding the plurality of sheets at the weld area.
